(19) United States
(12) Patent Application Publication
(10) Pub. No.: US 2019/0042295 A1
(43) Pub. Date: Feb. 7, 2019

(54) TIMING COMPENSATION FOR A TIMESTAMP COUNTER

(71) Applicant: Intel Corporation, Santa Clara, CA (US)

(72) Inventors: Liang Ma, Shannon (IE); John Joseph Browne, Limerick (IE); Xuebin Yang, Portland, OR (US); Tomasz Kantecki, Ennis (IE); Andrew J. Herdrich, Hillsboro, OR (US)

(73) Assignee: Intel Corporation, Santa Clara, CA (US)

(21) Appl. No.: 16/024,554

(22) Filed: Jun. 29, 2018

(51) Int. Cl. G06F 9/455

(52) U.S. Cl. CPC G06F 9/45558; G06F 2009/45575

(57) ABSTRACT

Particular embodiments described herein provide for an electronic device that can be configured to receive a request for a timestamp associated with a virtual machine, determine a current time from a timestamp counter, and subtract a timing compensation from the current time from the timestamp counter to create the timestamp, where the timing compensation includes an amount of time that execution of the virtual machine was suspended. In an example, a VM_EXIT instruction was used to suspend execution of the virtual machine and the timestamp counter was read before the VM_EXIT instruction was processed by a hypervisor.

### TECHNICAL FIELD

This disclosure relates in general to the field of computing and/or networking, and more particularly, to a timing compensation for a timestamp counter.

### BACKGROUND

Emerging network trends in data centers and cloud systems place increasing performance demands on a system. The increasing demands can cause an increase of the use of resources in the system. The resources have a finite capability and each of the resources need to be managed. One factor is managing resources is the ability to generate an accurate timestamp.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram of a system to enable a timing compensation for a timestamp counter, in accordance with an embodiment of the present disclosure;

FIG. 2 is a block diagram of a portion of a system to enable a timing compensation for a timestamp counter, in accordance with an embodiment of the present disclosure;

FIG. 3 is a block diagram of a portion of a system to enable a timing compensation for a timestamp counter, in accordance with an embodiment of the present disclosure;

FIG. 4 is a block diagram of a timing diagram illustrating example details to enable a timing compensation for a timestamp counter, in accordance with an embodiment of the present disclosure;

FIG. 5 is a block diagram of a timing diagram illustrating example details to enable a timing compensation for a timestamp counter, in accordance with an embodiment of the present disclosure;

FIG. 6 is a flowchart illustrating potential operations that may be associated with the system in accordance with an embodiment;

FIG. 7 is a flowchart illustrating potential operations that may be associated with the system in accordance with an embodiment;

FIG. 8 is a flowchart illustrating potential operations that may be associated with the system in accordance with an embodiment; and

FIG. 9 is a flowchart illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to a system, method, apparatus, etc. for a timing compensation for a timestamp counter, in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

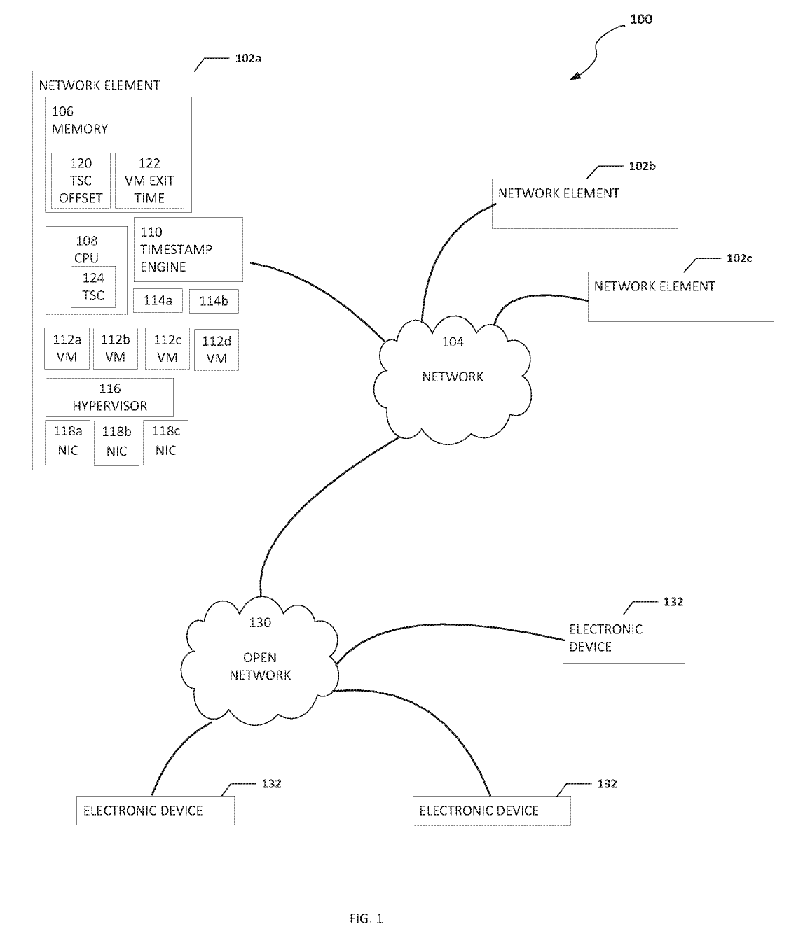

FIG. 1 is a simplified block diagram of a system configured to enable a timing compensation for a timestamp counter (TSC), in accordance with an embodiment of the present disclosure. In an example, a system 100 can include one or more network elements 102a-102c. Each network element 102a-102c can be in communication with each other using network 104. In an example, network elements 102a-102c and network 104 are part of a data center. Network elements 102a-102c can each include memory, one or more computer processing units (CPUs), a timestamp engine, one or more virtual machines (VMs), one or more processes, a hypervisor, and one or more network interface controllers (NICs). For example, network element 102a includes memory 106, a computer processing unit (CPU) 108, a timestamp engine 110, one or more VMs 112a-112d, one or more processes 114a and 114b, a hypervisor 116, and one or more network interface controllers (NICs) 118a-118c.

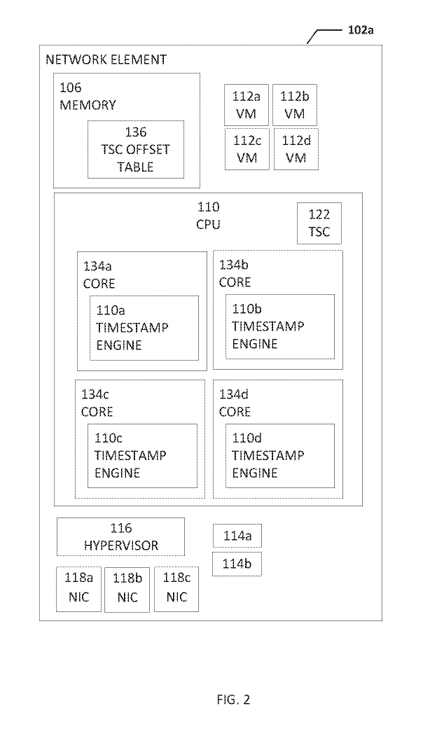

CPU 108 can include one or more cores or sockets and each core or socket can have an associated timestamp engine 110 (as illustrated in FIG. 2). In addition, CPU 108 can include a TSC 124. A TSC is a hardware feature found on many current processors. More specifically, TSC 124 is a 64-bit register present on x86 processors that counts the number of cycles since the last reset of the processor. TSC 124 is a special register which is simply incremented every clock cycle. Since TSC 124 is the fundamental unit of time as seen by the processor, TSC 124 provides high-resolution timing information and because TSC 124 is a CPU register, it can be read relatively quickly. A read timestamp counter (RDTSC) instruction reads the current value of TSC 124. Timestamp engine 110 can be configured to determine a relatively accurate timestamp that relates to when a VM is actually being executed. For example, timestamp engine 110 can calculate a timing compensation by adding an offset (i.e., the value of TSC when the VM began execution) and the total amount of time that the VM suspended execution.

Hypervisor 116 can be configured as a virtual machine manager (VMM). Hypervisor 116 can be computer software, firmware or hardware that creates and runs virtual machines (e.g., VMs 112a-112d). A VM is a software computer that, like a physical computer, runs an operating system and applications. The virtual machine is comprised of a set of specification and configuration files and is backed by the physical resources of a host.

A computer (e.g., network element 102a) on which a hypervisor runs one or more virtual machines is called a host machine, and each virtual machine is called a guest machine. The hypervisor presents the guest operating systems with a virtual operating platform and manages the execution of the guest operating systems. Multiple instances of a variety of operating systems may share the virtualized hardware resources: for example, Linux, Windows, and macOS instances can all run on a single physical x86 machine. This contrasts with operating-system-level virtualization, where all instances (usually called containers) must share a single kernel, though the guest operating systems can differ in user space, such as different Linux distributions with the same kernel. Hypervisor 116 can be configured to allow multiple VMs, commonly referred to as guests and/or guest OSs, to run concurrently on network element 102a. It is so named because it is conceptually one level higher than a supervisory program. Multiple instances of a variety of VMs may share virtualized hardware resources.

Each process 114a and 114b may be a process, application, function, virtual network function (VNF), etc. NICs 118a-118c, (also known as a network interface card, network adapter, LAN adapter or physical network interface, and other similar terms) can be a computer hardware component that connects a network element (e.g., network element 102a) to a network (e.g., network 104). Early network interface controllers were commonly implemented on expansion cards that plugged into a computer bus. The low cost and ubiquity of the Ethernet standard means that most newer computers have a network interface built into the motherboard. Modern network interface controllers offer advanced features such as interrupt and DMA interfaces to the host processors, support for multiple receive and transmit queues, partitioning into multiple logical interfaces, and on-controller network traffic processing such as the TCP offload engine.

Network 104 can be in communication with open network 130 (e.g., the Internet). Open network 130 can be in communication with electronic devices 132. Electronic devices 132 may be user equipment, cloud services, or some other type of electronic device that is in communication with network 104 through open network 130.

System 100 can be configured to obtain the value of TSC 124 before hypervisor 116 begins processing a VM_EXIT instruction. The VM_EXIT instruction causes execution of the VM to be suspended or stop. In a bare mental system, an OS can use a RDTSC instruction to get the value (e.g., cycle count information) of TSC 124. However, a VM (e.g., VM 112a) using the RDTSC instruction will get the value of TSC 124 multiplied by a multiplier minus a fixed offset. The multiplier is scaling to account for different clock rates of different processors. The fixed offset is the difference in time from when the host (e.g., network element 102a) started or came online to when the VM began execution. However, the offset is subject to non-deterministic jitter introduced by the VM_EXIT having to be processed by hypervisor 116 acting as a VMM and existing RDTSC behavior inside the VM. One VM_EXIT will cost around two thousand (2,000) cycles. After the VM_EXIT, the VM is not consuming any processor cycles, but the cycle number is still taken into account in the above formulation. This will disturb the measured cycle count significantly in frequent VM_EXITs. Even if the offset field inside the VMCS structure was updated every time a VM_EXIT occurred, it would still be too late because when hypervisor 116 sees the VM_EXIT instruction, TSC 124 has already included the VM_EXIT (about 2000 cycles). System 100 can be configured to use a process to store the VM instance specific timestamp counter number before execution of the VM_EXIT instruction is started by hypervisor 116 to accurately record the non-deterministic time during the VM_EXIT. Using timestamp engine 110, system 100 can also be configured to factor in the time when the VM is not consuming processor cycles and to recover and correct the stored time when the original VM instance is loaded back to physical processor.

It is to be understood that other embodiments may be utilized and structural changes may be made without departing from the scope of the present disclosure. Substantial flexibility is provided by system 100 in that any suitable arrangements and configuration may be provided without departing from the teachings of the present disclosure. Elements of FIG. 1 may be coupled to one another through one or more interfaces employing any suitable connections (wired or wireless), which provide viable pathways for network (e.g., network 104, etc.) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment.

For purposes of illustrating certain example techniques of system 100, the following foundational information may be viewed as a basis from which the present disclosure may be properly explained. End users have more media and communications choices than ever before. A number of prominent technological trends are currently afoot (e.g., more computing devices, more online video services, more Internet traffic), and these trends are changing the media delivery landscape. Data centers serve a large fraction of the Internet content today, including web objects (text, graphics, Uniform Resource Locators (URLs) and scripts), downloadable objects (media files, software, documents), applications (e-commerce, portals), live streaming media, on demand streaming media, and social networks. In addition, devices and systems, such as data centers, are expected to increase performance and function. However, the increase in performance and/or function can cause bottlenecks within the resources of the system and electronic devices in the system. One of the components of managing a system is a timestamp. However, providing an accurate timestamp can be difficult, especially for VMs when the VMs suspend or pause execution.

A virtualized hardware platform can have multiple virtual machines running on it with each one providing independent services to users. Network function virtualization (NFV) is a concept that virtualizes entire classes of network node functions into building blocks that may connect, or chain together, to create communication services. A node includes a redistribution point, communication endpoint, etc. The definition of a node depends on the network and protocol layer. A network node can be an active electronic device that is attached to a network and is capable of creating, receiving, or transmitting information over a communications channel. NFV relies upon, but differs from, traditional server-virtualization techniques, such as those used in enterprise IT. A virtualized network function, or VNF, may consist of one or more virtual machines running different software and processes, on top of standard high-volume servers, switches and storage devices, or even cloud computing infrastructure, instead of having custom hardware appliances for each network function. Timing accuracy is critical in NFV telecommunications applications for accurate timestamping of telemetry and real-time scheduling activities in 3G/4G/5G LTE/EPC, Wi-Fi and Wi-Gig, etc.

Some existing approaches to attempt to address timing accuracy include using TSC offsetting. TSC offsetting allows a VMM (e.g., a hypervisor) to specify a TSC offset that is added to the actual TSC value when it is read. A VMM can use the TSC offset to provide a guest (e.g., VM 112a) with the illusion that the guest is operating at a time later or earlier than what is represented by the actual current TSC value.

Various hypervisors have attempted to address the problem of accurate TSC synchronization between host and guest. Some current systems use native or pass-through access to the TSC. These systems can be relatively fast but are often incorrect and provide no emulation by a hypervisor as the instruction is directly executed on physical CPUs. This can have relatively fast performance but may cause TSC synchronization issues to TSC sensitive applications in a guest OS.

Some other current systems use an emulated or trap of the TSC. These systems can be accurate but are typically slow and require full virtualization. In these systems, often the hypervisor will emulate the TSC and the RDTSC instruction is not directly executed on physical CPUs. This can cause degraded performance for RDTSC instructions but allows for reliability for TSC sensitive applications. Other current systems use a para virtualization (PV) of TSC. In these systems, in order to optimize the RDTSC performance, some hypervisors provide PV RDTSC which allows software in a VM to be para-virtualized or modified for better performance. However, if a user application in the VM directly issues the RDTSC instruction, the PV solution cannot work. Still other current systems use a hybrid TSC which can provide the correct time but are potentially slow.

Some current systems use a kernel-based virtual machine (KVM) method. KVM is a virtualization infrastructure that turns the kernel into a hypervisor. In the KVM method, the common process to get timing information is to use a timestamp cycle count based on how many cycles have passed since the processor was in cold boot. In a bare mental system, the OS can use the RDTSC instruction to get the cycle count information. Inside a guest OS, depending on the virtual machine control structure (VMCS) configuration, the guest using RDTSC will get the physical cycle count times a multiplier, minus a fixed offset (e.g., (Guest) cycle count=(physical cycle count)*multiplier (TSC scaling)−FIXED_OFFSET (which is when the VM was started)). However, the KVM method is subject to non-deterministic jitter introduced by the cost of a VM_EXIT and existing RDTSC behavior inside the VM.

The VMCS is a data structure in memory exists exactly once per VM, and is managed by the VMM. With every change of the execution context between different VMs, the VMCS is restored for the current VM, defining the state of the VM's virtual processor. The VMCS region comprises up to 4-Kbytes. At a byte offset of zero, bits 30:0 include VMCS revision identifier and bit 31 includes a shadow VMCS indicator. As soon as more than one VMM or nested VMMs are used, a problem appears in a way similar to the problem that required shadow page table management. In such cases, VMCS needs to be shadowed multiple times (in case of nesting) and partially implemented in software in case there is no hardware support by the processor. A VMX-abort indicator is located at a byte offset of four. Byte offset eight includes VMCS data in an implementation specific format,

The KVM method and the other current methods are not accurate for a number of reasons. One disadvantage is the non-deterministic jitter introduced by the VM_EXIT exit instruction. More specifically, one VM_EXIT will cost around two thousand (2,000) cycles. After the VM_EXIT, the guest OS is not consuming any processor cycles, but the cycle number is still taken into account in the above formulation. This will disturb the measured cycle count significantly in frequent VM_EXITs. Even if the KVM method is optimized by updating the offset field inside the VMCS structure every time a VM_EXIT occurred, it would still be too late because when the hypervisor sees the VM_EXIT instruction, the TSC value has already included the VM_EXIT (about 2,000 cycles). In many instances, the VM_EXIT can happen very frequently and the number can be hundreds per second or even ten thousand per second.

In addition, the processor and/or value in TSC can drift. In a best case scenario, the drift only includes the VM_EXIT, (e.g., drift equals the number of VM_EXITs multiplied by 2,000 cycles). However, the hypervisor always needs to take time to process the VM_EXIT and the real drift can be much bigger (e.g., the real drift is equal to the number of VM_EXITs multiplied by 2,000 cycles plus the varied VM_EXIT processing time). Another disadvantage is when multiple VMs are running on the same physical core. For example, if VM1 is swap out and VM2 begins execution, then VM1 resumes back to the same physical core, the VM1 TSC value will include the VM2 running time. What is needed is a system and method to keep the clock timing related to a VM relatively accurate.

A device to help keep the clock timing related to a VM relatively accurate, as outlined in FIG. 1, can resolve these issues (and others). In an example, system 100 can be configured to keep the clock timing in a VM relatively accurate, about as accurate as the OS clock timing in a host OS, by using a timing compensation that can help to eliminate the drift caused by non-deterministic virtualization effects. For example, system 100 can be configured for timing critical applications within the VMM, in combination with an accurate compensation measurement or timing compensation, to automatically correct non-deterministic timing latencies.

TSC offsetting is a process that allows a VMM to specify a value (the TSC offset) that is added to the TSC when it its read by a guest. A VMM can use this feature to provide the guest (e.g., VM 112a) with the illusion that is operating at a time earlier than that represented by the current TSC value. With TSC offsetting, the guest perceives a TSC that is different from the real hardware, but which advances at the same rate. That may be adequate for usages in which the offset is used for execution time for the virtual machine that was created. However, the existing standard approach does not address the use case when a time critical application requires an accurate representation of time. System 100 can be configured to have more accurate timing compared to existing schemes, as the timing compensation timing correction avoids the non-deterministic jitter introduced by the cost of a VM_EXIT which can be in the range of about 2,000 cycles.

The RDTSC and RDTSCP instructions both read the CPU's TSC. The RDTSCP instruction is a serializing variant of the RDTSC instruction. The TSC is a timestamp model specific register (MSR). MSRs include various control registers in the x86 instruction set used for debugging, program execution tracing, computer performance monitoring, and toggling certain CPU features. Because the TSC is a MSR, the guest or VM using the RDTSC/RDTSCP instruction must suspend or pause execution while the TSC value is obtained. The response to the RDTSC/RDTSCP instruction is a value that is equal to the physical cycle count of the TSC times a multiplier (TSC scaling) minus a FIXED_OFFSET (when the VM is started). The FIXED_OFFSET is an existing MSR which is part of the virtual machine control structure (VMCS).

System 100 can be configured to track non-deterministic time during a VM_EXIT and automatically correct the time when the VM is restored. More specifically, system 100 can be configured to use a process to store the VM instance specific timestamp counter number before the VM_EXIT is started, to accurately record the non-deterministic time during the VM_EXIT, and to recover and correct the stored time when the original VM instance is loaded back to physical processor. In this way, the inaccurate part of timing can be eliminated.

The current hypervisor VM control structure and offset fields are kept for backwards compatibility and migration reasons. In an example, additions can be added to the VM control structure (VMCS structure) In the VM-EXECUTION control section. More specifically, two 64-bit fields can be added, a VM_EXIT_TIME and a VM_NOT_EXECUTING instruction. When a VM_EXIT instruction is received, a VM_EXIT_TIME instruction will provide the physical time counter value. The VM_EXIT_TIME value is equal to the current value of the TSC times a multiplier. When the VM is not being executed, a VM_NOT_EXECUTING instruction will provide the time that the VM was not executing. The VM_NOT_EXECUTING value can be equal to the TSC times a multiplier minus the offset and the time that the VM was not executing. Also, an associate control flag bit can be added in the control filed which can disable/enable this feature. The offset plus the VM_NOT_EXECUTING value is the timing compensation for the VM.

System 100 is compatible with existing TSC designs, which will allow applications to maintain a notion of real-world time simultaneously with precise event measurement (e.g., 5G packet processing), that can be done through a new hardware register (VMCS Structure) in the guest. The option of which TSC value to present as primary value or a secondary value could then be made by the hypervisor.

Turning to the infrastructure of FIG. 1, system 100 in accordance with an example embodiment is shown. Generally, system 100 may be implemented in any type or topology of networks. Network 104 represents a series of points or nodes of interconnected communication paths for receiving and transmitting packets of information that propagate through system 100. Network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, network elements 102a-102c, are meant to encompass network elements, network appliances, servers, routers, switches, gateways, bridges, load balancers, processors, modules, or any other suitable device, component, element, or object operable to exchange information in a network environment. Network elements 102a-102c may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of network elements 102a-102c may be virtual or include virtual elements.

In regard to the internal structure associated with system 100, each of network elements 102a-102c can include memory elements (e.g., memory 106) for storing information to be used in the operations outlined herein. Each of network elements 102a-102c may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media or machine-readable media. In some of these instances, memory elements can store data used for the operations described herein. This includes the memory elements being able to store software, logic, code, or processor instructions that are executed to carry out the activities described herein.

In an example implementation, elements of system 100, such as network elements 102a-102c may include software modules (e.g., timestamp engine 110, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of network elements 102a-102c may include one or more processors (e.g., CPU 108) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

Turning to FIG. 2, FIG. 2 is a simplified block diagram of a portion of network element 102a. In an example, network element 102a can include memory 106, CPU 108, one or more virtual machines 112a-112d, one or more processes 114a and 114b, hypervisor 116, and one or more NICs 118a-118c. Memory 106 can include TSC timing compensation table 136. TSC timing compensation table 136 can include offsets, exit times, resume times, timing compensations, and other data for specific VMs that will help system 100 and/or timestamp engine 110 determine accurate clock timing related to a specific VM. CPU 108 can include one or more cores and each core can include or be associated with a timestamp engine. For example, as illustrated in FIG. 2, CPU 108 includes cores 134a-134d. Core 134a can include or be associated with timestamp engine 110a, core 134b can include or be associated with timestamp engine 110b, core 134c can include or be associated with timestamp engine 110c, and core 134d can include or be associated with timestamp engine 110d. Each core 134a-134d can be a core, socket, thread, etc. of a CPU or processor.

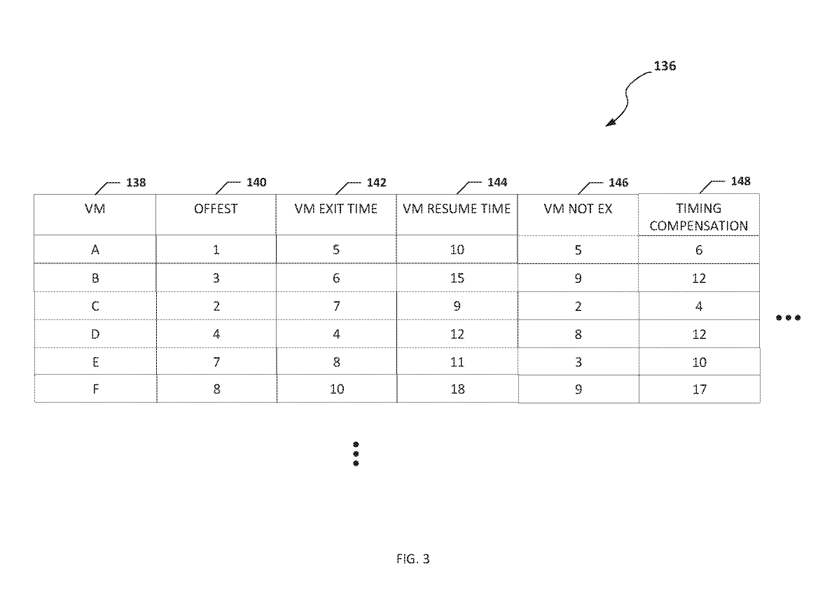

Turning to FIG. 3, FIG. 3 is a simplified block diagram of TSC timing compensation table 136 in accordance with an embodiment of the present disclosure. TSC timing compensation table 136 can include a VM column 138, an offset column 140, a VM exit time column 142, a VM resume time column 144, a VM not executing column 146, and a timing compensation column 148. Note that the offset value in offset column 140, the VM exit time value in VM exit time column 142, the VM resume value in VM resume time column 144, the VM not executing value in VM not executing column 146, and the timing compensation value in timing compensation column 148 may be a number of CPU cycles and not as a measurement of time such as seconds or minutes and the use of a measurement of time, such as seconds or minutes, is only for simplicity and illustration purposes.

VM column 138 can include an identifier that helps to identify a specific VM (e.g., VM 112a-112d). Offset column 140 can include an offset that is associated with a specific VM identified in VM column 138. The offset in offset column 140 is the time when the VM identified in VM column 138 began execution minus the time when the host (e.g., network element 102a) became active. If TSC was zero when the host became active then the offset would be the value of the TSC when the VM began execution. VM exit time column 142 can include an exit time of a specific VM identified in VM column 138. The exit time in VM exit time column 142 is the VM_EXIT_TIME value and is the time when the VM identified in VM column 138 suspended or paused execution. VM resume time column 144 can include a resume time of a specific VM identified in VM column 138. The resume time in VM resume time column 144 is the time when the VM identified in VM column 138 resumed execution after suspending or pausing execution.

VM not executing column 146 can include the time a VM identified in VM column 138 was not executing. The value in VM not executing column 146 can be determined by subtracting the VM exit time in VM exit time column 142 from the VM resume time in VM resume time column 144. In a specific example, the VM_NOT_EXECUTING value can be updated each time the VM suspends or pauses execution. Then the TSC value for the VM can be calculated by multiplying the TSC by a multiplier and subtracting the offset value and the VM_NOT_EXECUTING value.

Timing compensation column 148 can include the time from when TSC was zero that a VM identified in VM column 138 was not executing. The value in timing compensation column 148 can be determined by adding the offset time in offset column 140 and the VM_NOT_EXECUTING time in VM not executing column 146 to get the total time that a VM identified in VM column 138 was not executing. In a specific example, the timing compensation can be updated each time the VM suspends or pauses execution. Then the TSC value for the VM can be calculated by multiplying the TSC by a multiplier and subtracting the timing compensation value.

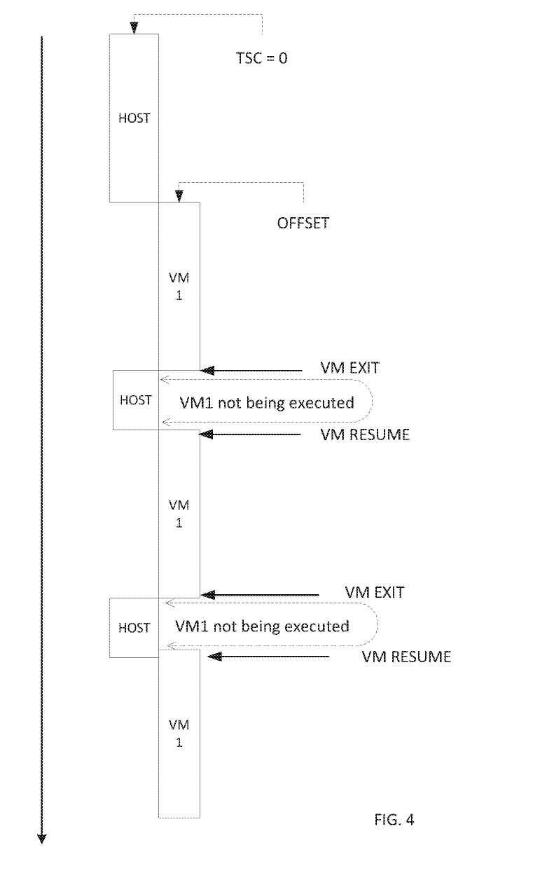

Turning to FIG. 4, FIG. 4 is a simplified block timing diagram in accordance with an embodiment of the present disclosure. In an example, when a host (e.g., network element 102a) begins running, operating, comes online, etc. the value in TSC (e.g., TSC 124) is zero. In other examples, the value in TSC may be something other than zero or the value in TSC may be set to zero for reasons other than when the host begins, operating, comes online, etc. After the host is running, a VM (e.g., VM 112a) can start executing and an offset is recorded to indicate the time when the VM stated executing. For example, if the VM started executing five (5) minutes after the host began running, operating, came online, etc., then the offset would be five (5) minutes. The offset can be recorded in TSC timing compensation table 136 illustrated in FIG. 3. Note that the offset may be recorded as a number of CPU cycles, not as a measurement of time such as seconds or minutes and the use of a measurement of time, such as seconds or minutes, is only for simplicity and illustration purposes.

After the VM has been executing, the VM may need to suspend or pause execution. The VM may need to suspend or pause execution to request a service from a hypervisor (e.g., hypervisor 116), to switch operating context to the hypervisor to perform some function on behalf of the VM, or for some other reason in which the VM needs to suspend or pause execution. The time when the VM suspends or pauses execution can be recorded as a VM EXIT time in TSC timing compensation table 136 illustrated in FIG. 3.

After the VM resumes execution, the time when the VM resumed execution can be recorded as a VM RESUME time in TSC timing compensation table 136 illustrated in FIG. 3. The VM_NOT_EXECUTING value can be updated with the time the VM was not executing by subtracting VM EXIT time from the VM RESUME time. For example, the host can begin running, operating, come online, etc., five minutes later, the VM may begin execution. After VM has been executing for 10 minutes, VM may need to suspend or pause execution to request a service from hypervisor (e.g., perform a privileged operation, access a privileged register, perform a secure process, access a page table, respond to an external interrupt, etc.). VM may resume execution after one minute (note the actual time would be much shorter (i.e., a few CPU cycles) and one minute is only used for simplicity and illustration purposes). If the TSC value for the VM was not updated to account for the one minute that VM was not executing, then the TSC value for the VM would be off by the one minute. This process can be repeated for multiple iterations where the VM begins execution, suspends or pauses execution, and resumes execution. Even if the pause in execution is only for a few CPU cycles, the few CPU cycles can add up to a relatively large number after several suspensions or pauses.

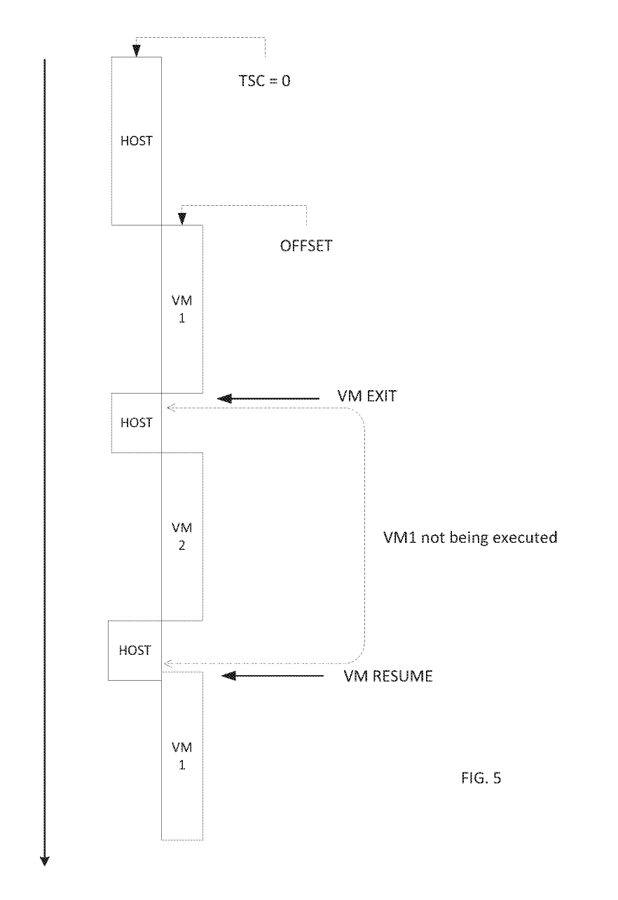

Turning to FIG. 5, FIG. 5 is a simplified block timing diagram in accordance with an embodiment of the present disclosure. In an example, when a host (e.g., network element 102a) begins running, operating, comes online, etc. the value in TSC (e.g., TSC 124) is zero. In other examples, the value in TSC may be something other than zero or the value in TSC may be set to zero for reasons other than when the host begins, operating, comes online, etc. After the host is running, a VM (e.g., VM 112a) can start executing and an offset is recorded to indicate the time when the VM stated executing. For example, if the VM started executing five (5) minutes after the host began running, operating, came online, etc., then the offset would be five (5) minutes. The offset can be recorded in TSC timing compensation table 136 illustrated in FIG. 3.

After the VM has been executing, the host may suspend the execution of the VM so a different VM (e.g., VM 112b) can begin execution or the host may suspend the execution of the VM for other reasons. The time when the execution of VM is suspended or paused can be recorded as a VM EXIT time in TSC timing compensation table 136 illustrated in FIG. 3. After the VM resumes execution, the time when the VM resumed execution can be recorded as a VM RESUME time in TSC timing compensation table 136 illustrated in FIG. 3. The VM_NOT_EXECUTING value can be updated with the time the VM was not executing by subtracting VM EXIT time from the VM RESUME time. This way, the time it took for VM_EXIT to occur as well as the time VM was not being executed will not count as VM operating or execution time. In addition, system 100 can be configured to store the VM instance specific timestamp counter number before the VM_EXIT is started or executed by the hypervisor to accurately record the non-deterministic time during the VM_EXIT and to recover and correct the stored time when the original VM instance is loaded back to physical processor. Thus, the VM can operate under the illusion that is operating at a relatively accurate time that is earlier than that represented by the current TSC value.

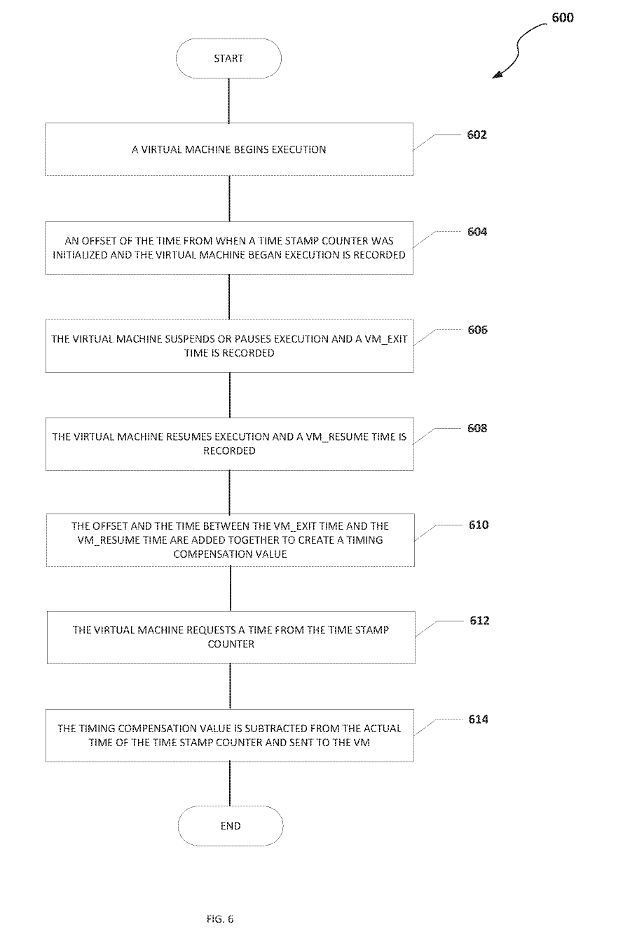

Turning to FIG. 6, FIG. 6 is an example flowchart illustrating possible operations of a flow 600 that may be associated with a timing compensation for a TSC, in accordance with an embodiment. In an embodiment, one or more operations of flow 600 may be performed by CPU 108, timestamp engine 110, hypervisor 116, etc. At 602, a VM begins execution. At 604, an offset of the time from when a TSC was initialized and the VM began execution is recorded. For example, the TSC may have been initialized or set to zero when a host began operation. At 606, the VM suspends or pauses execution and a VM_EXIT time is recorded. For example, the VM instance specific TSC value can be stored before the VM_EXIT instruction is started or executed by the hypervisor to accurately record the non-deterministic time during the VM_EXIT because when the hypervisor sees the VM_EXIT instruction, the TSC value has already included the VM_EXIT (about 2,000 cycles). The VM_EXIT time can be recorded in TSC timing compensation table 136 illustrated in FIG. 3. At 608, the VM resumes execution and a VM_RESUME time is recorded. For example, the VM_RESUME time can be recorded in TSC timing compensation table 136 illustrated in FIG. 3. At 610, the offset and the time between the VM_EXIT time and the VM_RESUME time are added together to create a timing compensation value. At 612, the VM requests a time from the TSC. At 614, the timing compensation value is subtracted from the actual time of the TSC and sent to the VM. In an example, a process or element other than the VM requests a time associated with the VM from the TSC and the timing compensation value is subtracted from the actual time of the TSC and sent to the process or element that requested the time associated with the VM.

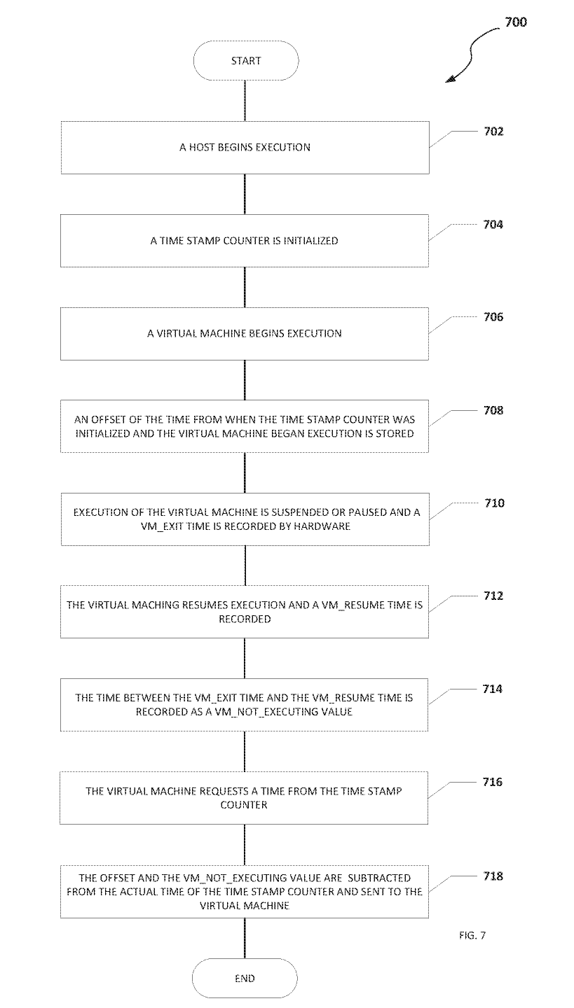

Turning to FIG. 7, FIG. 7 is an example flowchart illustrating possible operations of a flow 700 that may be associated with a timing compensation for a TSC, in accordance with an embodiment. In an embodiment, one or more operations of flow 700 may be performed by CPU 108, timestamp engine 110, hypervisor 116, etc. At 702, a host begins execution. For example, a host (e.g., network element 102a) can become active or come online. At 704, a TSC is initialized. For example, the value of TSC may be set to zero. At 706, a VM begins execution. At 708, an offset of the time from when the TSC was initialized and the VM began execution is stored. At 710, execution of the VM is suspended or paused and a VM_EXIT time is recorded by hardware. At 712, the VM resumes execution and a VM_RESUME time is recorded. At 714, the time between the VM_EXIT and the VM_RESUME is recorded as a VM_NOT_EXECUTING value. At 716, the VM requests a time from the TSC. At 718, the offset and the VM_NOT_EXECUTING value are subtracted from the actual time of the TSC and sent to the VM. In an example, a process or element other than the VM requests a time associated with the VM from the TSC and the offset and the VM_NOT_EXECUTING value are subtracted from the actual time of the TSC and sent to the process or element that requested the time associated with the VM.

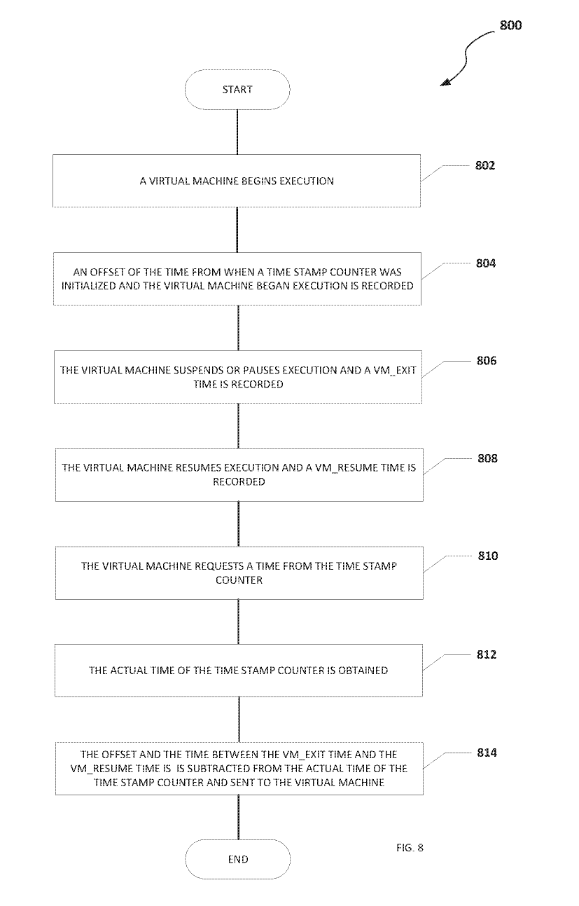

Turning to FIG. 8, FIG. 8 is an example flowchart illustrating possible operations of a flow 800 that may be associated with a timing compensation for a TSC, in accordance with an embodiment. In an embodiment, one or more operations of flow 800 may be performed by CPU 108, timestamp engine 110, hypervisor 116, etc. At 802, a VM begins execution. At 804, an offset of the time from when a TSC was initialized and the VM began execution is recorded. At 806, the VM suspends or pauses execution and a VM_EXIT time is recorded. At 808, the VM resumes execution and a VM_RESUME time is recorded. At 810, the VM requests a time from the TSC. At 812, the actual time of the TSC is obtained. At 814, the offset and the time between the VM_EXIT time and the VM_RESUME time is subtracted from the actual time of the TSC and sent to the VM.

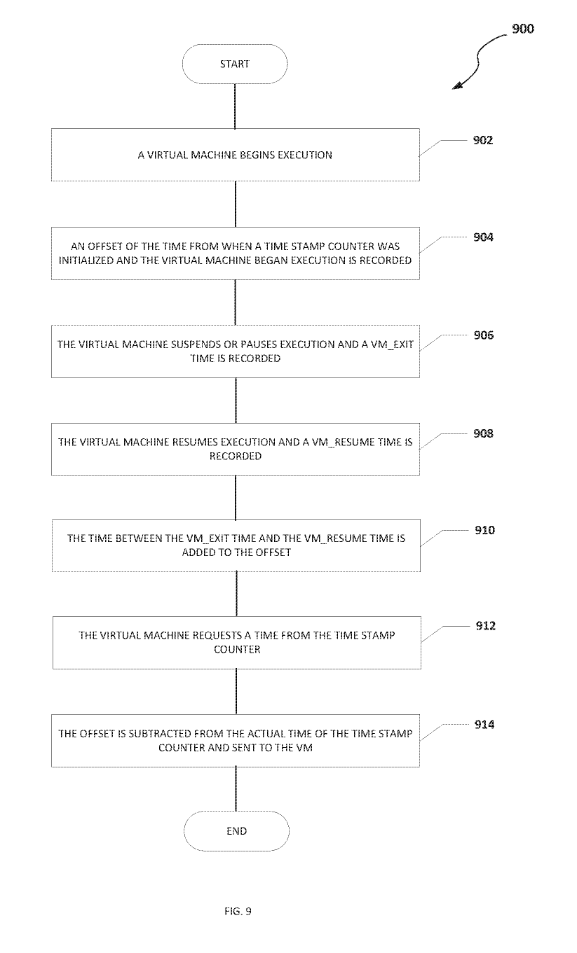

Turning to FIG. 9, FIG. 9 is an example flowchart illustrating possible operations of a flow 900 that may be associated with a timing compensation for a TSC, in accordance with an embodiment. In an embodiment, one or more operations of flow 900 may be performed by CPU 108, timestamp engine 110, hypervisor 116, etc. At 902, a VM begins execution. At 904, an offset of the time from when a TSC was initialized and the VM began execution is recorded. For example, the TSC may have been initialized or set to zero when a host began operation. At 906, the VM suspends or pauses execution and a VM_EXIT time is recorded. For example, the VM instance specific TSC value can be stored before the VM_EXIT instruction is started to accurately record the non-deterministic time during the VM_EXIT because when the hypervisor sees the VM_EXIT instruction, the TSC value has already included the VM_EXIT (about 2,000 cycles). The VM_EXIT time can be recorded in TSC timing compensation table 136 illustrated in FIG. 3. At 908, the VM resumes execution and a VM_RESUME time is recorded. For example, the VM_RESUME time can be recorded in TSC timing compensation table 136 illustrated in FIG. 3. At 910, the time between the VM_EXIT time and the VM_RESUME time is added to the offset. At 912, the VM requests a time from the TSC. At 914, the offset is subtracted from the actual time of the TSC and sent to the VM. In an example, a process or element other than the VM requests a time associated with the VM from the TSC and the offset is subtracted from the actual time of the TSC and sent to the process or element that requested the time associated with the VM.

It is also important to note that the operations in the preceding flow diagrams (i.e., FIGS. 6-9) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 have been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor, cause the at least one processor to receive a request for a timestamp associated with a virtual machine, determine a current time from a timestamp counter, and subtract a timing compensation from the current time from the timestamp counter to create the timestamp, where the timing compensation includes an amount of time that execution of the virtual machine was suspended.

In Example C2, the subject matter of Example C1 can optionally include where a VM_EXIT instruction was used to suspend execution of the virtual machine.

In Example C3, the subject matter of any one of Examples C1-C2 can optionally include where the timestamp counter was read before the VM_EXIT instruction was processed by a hypervisor.

In Example C4, the subject matter of any one of Examples C1-C3 can optionally include where the hypervisor is a virtual machine manager for the virtual machine.

In Example C5, the subject matter of any one of Examples C1-C4 can optionally include where execution of the virtual machine was suspended to perform a privileged operation.

In Example C6, the subject matter of any one of Examples C1-05 can optionally include where execution of the virtual machine was suspended to allow a different virtual machine to be executed.

In Example C7, the subject matter of any one of Examples C1-C6 can optionally include where the at least one machine readable medium is part of a data center.

In Example A1, an electronic device can include memory, a timestamp engine, and at least one processor. The timestamp engine is configured to cause the at least one processor to receive a request for a timestamp associated with a virtual machine, determine a current time from a timestamp counter, and subtract a timing compensation from the current time from the timestamp counter to create the timestamp, where the timing compensation includes an amount of time that execution of the virtual machine was suspended.

In Example A2, the subject matter of Example A1 can optionally include where a VM_EXIT instruction was used to suspend execution of the virtual machine.

In Example A3, the subject matter of any one of Examples A1-A2 can optionally include where the timestamp counter was read before the VM_EXIT instruction was processed by a hypervisor.

In Example A4, the subject matter of any one of Examples A1-A3 can optionally include where the hypervisor is a virtual machine manager for the virtual machine.

In Example A5, the subject matter of any one of Examples A1-A4 can optionally include where execution of the virtual machine was suspended to perform a privileged operation.

Example M1 is a method including receiving a request for a timestamp associated with a virtual machine, determining a current time from a timestamp counter, and subtracting a timing compensation from the current time from the timestamp counter to create the timestamp, where the timing compensation includes an amount of time that execution of the virtual machine was suspended.

In Example M2, the subject matter of Example M1 can optionally include a VM_EXIT instruction was used to suspend execution of the virtual machine.

In Example M3, the subject matter of any one of the Examples M1-M2 can optionally include where the timestamp counter was read before the VM_EXIT instruction was processed by a hypervisor.

In Example M4, the subject matter of any one of the Examples M1-M3 can optionally include where the hypervisor is a virtual machine manager for the virtual machine.

In Example M5, the subject matter of any one of the Examples M1-M4 can optionally include where execution of the virtual machine was suspended to perform a privileged operation.

In Example M6, the subject matter of any one of Examples M1-M5 can optionally include where execution of the virtual machine was suspended to allow a different virtual machine to be executed.

Example S1 is a system for generating a timestamp. The system can include memory, one or more processors, and a timestamp engine. The timestamp engine can be configured to receive a request for a time associated with the virtual machine, determine a current timestamp from a timestamp counter, and subtract a timing compensation from the current time from the timestamp counter to create the timestamp, where the timing compensation includes an amount of time that execution of the virtual machine was suspended.

In Example S2, the subject matter of Example S1 can optionally include where a VM_EXIT instruction was used to suspend execution of the virtual machine.

In Example S3, the subject matter of any one of the Examples S1-S2 can optionally include where the timestamp counter was read before the VM_EXIT instruction was processed by a hypervisor.

In Example S4, the subject matter of any one of the Examples S1-S3 can optionally include where the hypervisor is a virtual machine manager for the virtual machine.

In Example S5, the subject matter of any one of the Examples S1-S4 can optionally include where execution of the virtual machine was suspended to perform a privileged operation.

In Example S6, the subject matter of any one of the Examples S1-S5 can optionally include where execution of the virtual machine was suspended to allow a different virtual machine to be executed.

In Example S7, the subject matter of any one of the Examples S1-S6 can optionally include where the system is part of a data center.

Example AA1 is an apparatus including means for receiving a request for a timestamp associated with a virtual machine, means for determining a current time from a timestamp counter, and means for subtracting a timing compensation from the current time from the timestamp counter to create the timestamp, where the timing compensation includes an amount of time that execution of the virtual machine was suspended.

In Example AA2, the subject matter of Example AA1 can optionally include where a VM_EXIT instruction was used to suspend execution of the virtual machine.

In Example AA3, the subject matter of any one of Examples AA1-AA2 can optionally include where the timestamp counter was read before the VM_EXIT instruction was processed by a hypervisor.

In Example AA4, the subject matter of any one of Examples AA1-AA3 can optionally include where the hypervisor is a virtual machine manager for the virtual machine.

In Example AA5, the subject matter of any one of Examples AA1-AA4 can optionally include where execution of the virtual machine was suspended to perform a privileged operation.

In Example AA6, the subject matter of any one of Examples AA1-AA5 can optionally include where execution of the virtual machine was suspended to allow a different virtual machine to be executed.

In Example AA7, the subject matter of any one of Examples AA1-AA6 can optionally include where the at least one machine readable medium is part of a data center.

Example X1 is a machine-readable storage medium including machine-readable instructions to implement a method or realize an apparatus as in any one of the Examples A1-A5, AA1-AA7, or M1-M6. Example Y1 is an apparatus comprising means for performing any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. An electronic device comprising:
memory;
a timestamp engine; and
at least one processor, wherein the timestamp engine is configured to cause the at least one processor to:
receive a request for a timestamp associated with a virtual machine;
determine a current time from a timestamp counter; and
subtract a timing compensation from the current time from the timestamp counter to create the timestamp, wherein the timing compensation includes an amount of time that execution of the virtual machine was suspended.

2. The electronic device of claim 1, wherein a VM_EXIT instruction was used to suspend execution of the virtual machine.

3. The electronic device of claim 1, wherein the timestamp counter was read before the VM_EXIT instruction was processed by a hypervisor.

4. The electronic device of claim 3, wherein the hypervisor is a virtual machine manager for the virtual machine.

5. The electronic device of claim 1, wherein execution of the virtual machine was suspended to perform a privileged operation.

6. At least one machine readable medium comprising one or more instructions that, when executed by at least one processor, causes the at least one processor to:
receive a request for a timestamp associated with a virtual machine;
determine a current time from a timestamp counter; and
subtract a timing compensation from the current time from the timestamp counter to create the timestamp, wherein the timing compensation includes an amount of time that execution of the virtual machine was suspended.

7. The at least one machine readable medium of claim 6, wherein a VM_EXIT instruction was used to suspend execution of the virtual machine.

8. The at least one machine readable medium of claim 7, wherein the timestamp counter was read before the VM_EXIT instruction was processed by a hypervisor.

9. The at least one machine readable medium of claim 8, wherein the hypervisor is a virtual machine manager for the virtual machine.

10. The at least one machine readable medium of claim 6, wherein execution of the virtual machine was suspended to perform a privileged operation.

11. The at least one machine readable medium of claim 6, wherein execution of the virtual machine was suspended to allow a different virtual machine to be executed.

12. The at least one machine readable medium of claim 6, wherein the at least one machine readable medium is part of a data center.

13. A method comprising:
receiving a request for a timestamp associated with a virtual machine;
determining a current time from a timestamp counter; and
subtracting a timing compensation from the current time from the timestamp counter to create the timestamp, wherein the timing compensation includes an amount of time that execution of the virtual machine was suspended.

14. The method of claim 13, wherein a VM_EXIT instruction was used to suspend execution of the virtual machine.

15. The method of claim 14, wherein the timestamp counter was read before the VM_EXIT instruction was processed by a hypervisor.

16. The method of claim 15, wherein the hypervisor is a virtual machine manager for the virtual machine.

17. The method of claim 13, wherein execution of the virtual machine was suspended to perform a privileged operation.

18. The method of claim 13, wherein execution of the virtual machine was suspended to allow a different virtual machine to be executed.

19. A system for generating a timestamp for a virtual machine, the system comprising:
memory;
one or more processors; and
a timestamp engine, wherein the timestamp engine is configured to:
receive a request for a timestamp associated with the virtual machine;
determine a current time from a timestamp counter; and
subtract a timing compensation from the current time from the timestamp counter to create the timestamp, wherein the timing compensation includes an amount of time that execution of the virtual machine was suspended.

20. The system of claim 19, wherein a VM_EXIT instruction was used to suspend execution of the virtual machine.

21. The system of claim 20, wherein the timestamp counter was read before the VM_EXIT instruction was processed by a hypervisor.

22. The system of claim 21, wherein the hypervisor is a virtual machine manager for the virtual machine.

23. The system of claim 19, wherein execution of the virtual machine was suspended to perform a privileged operation.

24. The system of claim 19, wherein execution of the virtual machine was suspended to allow a different virtual machine to be executed.

25. The system of claim 19, wherein the system is part of a data center.
